(19) United States
(12) Patent Application Publication
(10) Pub. No.: US 2021/0310185 A1
(43) Pub. Date: Oct. 7, 2021

(54) BIODEGRADABLE SYNTHETIC LEATHER PRODUCED FROM RECYCLED MATERIAL

(71) Applicant: von Holzhausen, Pacific Palisades, CA (US)

(72) Inventors: Vicki von Holzhausen, Malibu, CA (US); Sara Elizabeth Pink, Los Angeles, CA (US)

(21) Appl. No.: 17/222,859

(22) Filed: Apr. 5, 2021

Related U.S. Application Data
(60) Provisional application No. 63/005,253, filed on Apr. 4, 2020.

(51) Int. Cl. D06N 3/00; D06N 3/14

(52) U.S. Cl. CPC D06N 3/0061; D06N 3/009; D06N 3/0011; D06N 3/14

(57) ABSTRACT

A synthetic leather is a layered material that includes a biodegradable layer, a backing layer, and an adhesive layer. The layered material is formed by bonding a first surface of the biodegradable layer to a first surface of the backing layer through the adhesive layer. In some embodiments, the biodegradable layer is made from a mixture of polyurethane (or other plastics such as polyvinyl chloride), a biodegradable additive, and in some cases, a colorant. The biodegradable additive in the mixture enhances biodegradability of polyurethane. In some embodiments, there is 1 to 2 wt % of the biodegradable additive in the synthetic leather. The backing layer is a layer of plastic fibers made from recycled plastic products. The plastic fibers can be PET, nylon, or acrylic fibers. A biodegradable coating may be formed on a second surface of the backing layer to further enhance biodegradability of the layered material.

### CROSS-REFERENCE TO RELATED APPLICATIONS

This application claims priority to U.S. Provisional Patent Application No. 63/005,253, filed on Apr. 4, 2020, which is incorporated by reference herein in its entirety.

### BACKGROUND

### Field of the Disclosure

The present disclosure generally relates to a synthesized material, and specifically to a synthesized material (e.g., leather) that is biodegradable and is produced from a recycled material.

### Description of the Related Arts

Leather is used in various industries, such as fashion, furniture, and automotive industries. However, producing leather has an enormous environmental footprint spanning the greenhouses gases emitted in cattle farming to the water and chemicals used in the tanning process. Livestock production is a main contributor of greenhouse gas emissions. Also, the leather tanning industry is one of the largest polluting industries in the world.

Synthetic leather materials have been developed and widely used as an alternative of animal leather due to the lower cost of these synthetic materials. However, currently available synthetic leathers are mostly made from unsustainable plastic (such as virgin plastic) that is not biodegradable, which also places a burden on the environment. Also, those synthetic leathers fail to provide the qualities of animal leather that consumers desire, so many consumers tend to still prefer animal leather, especially for premium consumer products. Thus, improved technology for producing synthetic leather is needed to achieve higher sustainability and better performance while maintaining a premium leather look and feel.

### SUMMARY

Embodiments relate to a synthetic material (e.g., synthetic leather), the composition of which is engineered to make it environmentally friendly and biodegradable, and engineered to also achieve a premium look and feel that mimics a non-synthetic version of the material (e.g., animal leather). Leather is provided as an example throughout, though the synthetic material is not limited to leather, but can include other synthetic materials designed to mimic a non-synthetic material.

The synthetic leather includes a biodegradable layer, a backing layer, and an adhesive layer. The biodegradable layer provides the look and feel that mimics animal leather. For instance, the biodegradable layer has a color, pattern, flexibility, and/or other characteristics of animal leather. The biodegradable layer comprises a mixture of a plastic and a biodegradable additive. The plastic is polyurethane, polyvinyl chloride, other plastics, or some combination thereof. The biodegradable additive enhances the biodegradability of the plastic so that the synthesized leather can be naturally degraded. In some embodiments, there is 1-3 wt % (e.g., 1-2 wt %) of the biodegradable additive in the synthesized leather. The biodegradable layer may further include a colorant that defines the color of the synthetic leather and a grain pattern and texture that mimics the grain pattern and texture of animal leather.

The backing layer provides a mechanical support to the synthetic leather. The backing layer includes plastic fibers. In some embodiments, the plastic of the backing layer is different from the plastic in the biodegradable layer. The plastic of the backing layer may be, e.g., polyethylene terephthalate (PET), nylon, acrylic, other thermoplastics, or some combination thereof. The plastic fibers can be produced from recycled products, e.g., bottles, clothing, equipment (such as tents, sails, fishing nets, etc.) or other types of consumer products. In some embodiments, the plastic fibers are entangled in a non-woven manner.

The adhesive layer bonds the backing layer to the biodegradable layer. In some embodiments, the adhesive layer is formed by applying an adhesive agent onto a first surface of the backing layer and/or a first surface of the biodegradable layer and applying pressure on at least one of the backing layer and the biodegradable layer to press the backing layer and the biodegradable layer against each other, e.g., under heat.

In some embodiments, the synthetic leather includes one or more biodegradable coatings to further enhance its biodegradability. For instance, the biodegradable coating can be a coating of a biodegradable additive sprayed onto a second surface of the backing layer, which opposes the first surface of the backing layer (e.g., is on an opposite side of the backing layer relative to the first surface). The biodegradable additive in the coating may be is tailored to the plastic in the backing layer, e.g., a biodegradable PET additive, to enhance biodegradation of the backing layer. As another example, the biodegradable coating can be a coating of biodegradable additive sprayed onto a second surface of the biodegradable layer, which opposes the first surface of the biodegradable layer (e.g., is on an opposite side of the biodegradable layer relative to the first surface). The biodegradable additive in the coating of this example may be tailored to the plastic of the biodegradable layer, e.g., a biodegradable polyurethane additive, to enhance biodegradation of the biodegradable layer. The biodegradable additive in the coatings may be a powder or a liquid.

### BRIEF DESCRIPTION OF THE DRAWINGS

The teachings of the embodiments can be readily understood by considering the following detailed description in conjunction with the accompanying drawings.

FIG. 1 is a perspective view of a synthetic leather, in accordance with an embodiment.

FIG. 2 is a cross-sectional view of another synthetic leather, in accordance with an embodiment.

FIG. 3 is a cross-sectional view of yet another synthetic leather, in accordance with an embodiment.

FIG. 4 illustrates a process of natural degradation of a synthetic leather, in accordance with an embodiment.

FIG. 5 is a flow chart illustrating a method for producing a synthetic leather, in accordance with an embodiment.

The figures depict various embodiments for purposes of illustration only.

### DETAILED DESCRIPTION

In the following description of embodiments, numerous specific details are set forth in order to provide more thorough understanding. However, note that the embodiments may be practiced without one or more of these specific details. In other instances, well-known features have not been described in detail to avoid unnecessarily complicating the description.

Embodiments are described herein with reference to the figures where like reference numbers indicate identical or functionally similar elements. Also, in the figures, the left most digits of each reference number correspond to the figure in which the reference number is first used.

Embodiments relate to a synthetic leather and a method of forming the synthetic leather.

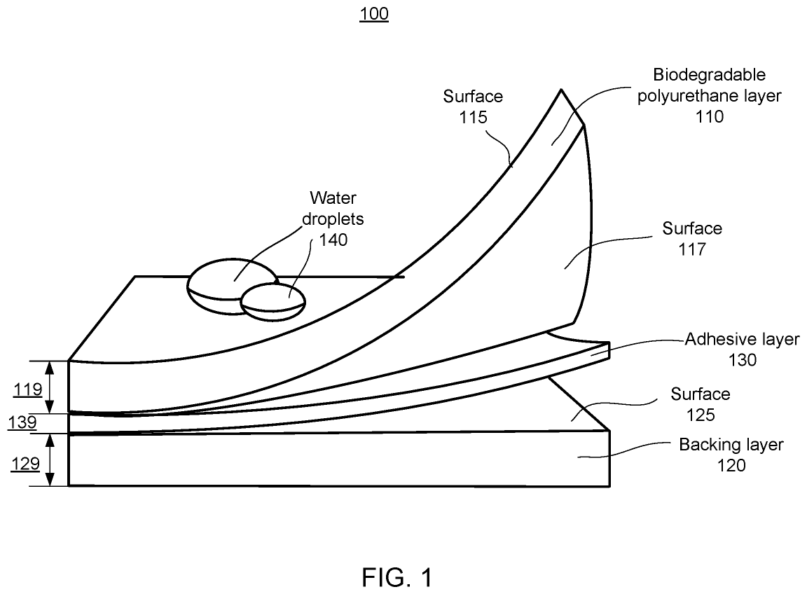

FIG. 1 is a perspective view of a synthetic leather 100, in accordance with an embodiment. The synthetic leather 100 is configured to be used as an alternative to animal leather. The synthetic leather 100 is biodegradable, e.g., in a landfill or marine environment, and can be broken down by microbes, which makes it cause less burden to the environment. Also, the synthetic leather 100 is at least partially produced from a recycled material. Thus, compared with animal leather, the synthetic leather 100 causes less greenhouse gas emission and less toxic chemical release, which makes it more environmentally friendly.

As shown in FIG. 1, the synthetic leather 100 includes a biodegradable polyurethane layer 110, a backing layer 120, and an adhesive layer 130. The synthetic leather 100 has a thickness between 0.6 mm to 1.0 mm. In some embodiments, the thickness of the synthetic leather 100 is in a range from 0.75 mm to 0.85 mm. (e.g., 0.55 mm, 0.6 mm, 0.65 mm, 0.7 mm, 0.8 mm or other thickness or sub-ranges within this range). In some other embodiments, the synthetic leather 100 may include different components. For instance, the synthetic leather 100 may include a biodegradable layer in lieu of the biodegradable polyurethane layer 110, which includes a different plastic material, e.g., polyvinyl chloride. As another example, the synthetic leather 100 may have different thicknesses outside of this range or 0.6 mm to 1.0 mm (e.g., 0.4 mm, or 1.1 mm, 1.2 mm, etc.).

The biodegradable polyurethane layer 110 provides a look and feel that mimics animal leather. The biodegradable polyurethane layer 110 comprises a mixture of polyurethane and a biodegradable additive. Polyurethane has physical properties and characteristics that makes it an attractive candidate to produce synthesized leather. For instance, polyurethane layers (e.g., coatings, sheets, etc.) are flexible like animal leather and are easy to be colored and patterned to make it look like animal leather. In some embodiment, there is 40-50 wt % of polyurethane in the synthetic leather 100.

The biodegradable additive enhances biodegradability of polyurethane. For instance, the biodegradable additive attracts microorganisms to the synthetic leather 100 when released into the ecosystem (e.g., a landfill condition or a marine condition) so that the synthesized leather can be naturally degraded. The biodegradable additive itself is biodegradable and may be plant-based. The amount of the biodegradable additive is carefully controlled to enable fast and thorough natural biodegradation of the synthetic leather 100, but without interfering with or compromising the physical properties or characteristics of the polyurethane. In some embodiments, there is 1-2 wt % of the biodegradable additive in the synthetic leather 100. The biodegradable additive may include starch, bioaugmentation compounds, pro-oxidant compounds, EVA (ethylene-vinyl acetate), or other types of compounds that can enhance biodegradability of plastics. Examples of the biodegradable additive includes, e.g., Eco-One® plastic additive, BioSphere® plastic additive, EcoPure® plastic additive, and so on.

The biodegradable polyurethane layer 110 may be made from renewable sources. In one example, the biodegradable polyurethane layer 110 is plant-based to avoid usage of toxic chemicals in the production of the biodegradable polyurethane layer 110 and to reduce emission of greenhouses gases. The polyurethane and the biodegradable additive in the mixture can be synthesized by using chemicals derived from plants. For instance, the source of multifunctional monomers and oligomers for synthesizing the polyurethane is plant oil.

The biodegradable polyurethane layer 110 may further include a colorant that defines the color of the synthetic leather 100. There can be 1-1.5 wt % (e.g., 1.1 wt %, 1.2 wt %, 1.3 wt %, 1.4 wt %, etc., or other values or sub-ranges within this range) of the colorant in the synthetic leather 100. In one embodiment, the mixture is generated by adding the colorant (e.g., liquid colorant) into polyurethane (e.g., liquid polyurethane) and then adding the biodegradable additive. The biodegradable additive may be in the form of a powder. In some embodiments, a thermal treatment is applied on the mixture to form the biodegradable polyurethane layer 110. For instance, the mixture is heated at a temperature in the range of 170° C. to 190° C. (e.g., 175° C., 180° C., 185° C., etc., or other values or sub-ranges within this range). After the heating, the mixture is cooled down, e.g., to room temperature by using a cooling roller at a cooling rate of 5° C. in 3-5 seconds, to form the biodegradable polyurethane layer 110.

In some embodiments, the thickness 119 of the biodegradable polyurethane layer 110 is 30% to 50% of the thickness of the synthetic leather 100. The thickness 119 may be from 0.20 mm to 0.34 mm (e.g., 0.20 mm, 0.25 mm, 0.3 mm, 0.33 mm, 0.34 mm, etc., and other values or sub-ranges within this range). The surface 115 is designed to be water resistant and therefore outperforms animal leather that typically is not water resistant. As shown in FIG. 1, the water droplets 140 on the surface 115 stay on the surface 115 and are not absorbed by the synthetic leather 100.

The surface 115 is smooth and has a look and feel similar to animal leather. In some embodiments, the surface 115 has a grain pattern and texture that mimics the grain pattern and texture of animal leather. The grain pattern and texture can be created by using a template that has a pattern, which, is, for example, a mirror image of the grain pattern and texture that is formed on the surface 115 using that template. An example of the template is a release paper. The template is attached onto the surface 115 of the biodegradable polyurethane layer 110 during the process of producing the biodegradable polyurethane layer 110 and/or the process of bonding the biodegradable polyurethane layer 110 to the backing layer 120 to imprint the pattern of the template onto the surface 115 to generate the grain pattern and texture. The template can be removed after the biodegradable polyurethane layer 110 is bonded to the backing layer 120.

In some embodiments, the biodegradable polyurethane layer 110 is configured to be a protective layer and to act as a barrier between the other layers of the synthetic leather 100 and the environment. For instance, the biodegradable polyurethane layer 110 provides the durability of the synthetic leather 100 and can withstand scratches.

The backing layer 120 provides a mechanical support to the synthetic leather 100. In some embodiments, the backing layer 120 has a thickness 129 that is in a range from 0.39 mm to 0.67 mm (e.g., 0.395 mm, 0.397 mm, 0.439 mm, 0.529 mm, 0.661 mm, etc., and other values or sub-ranges within this range). The backing layer 120 is a layer of plastic fibers. The plastic used to make the backing layer 120 can be polyethylene terephthalate (PET), nylon, acrylic, other thermoplastics, or some combination thereof. In some embodiments, the plastic fibers are produced from recycled plastic products, such as recycled bottles, recycled fabrics, or other types of recycled consumer products. For instance, the recycled plastic products are cleaned, melted, and spun into the plastic fibers. The backing layer 120 itself can also be recycled for a different use. Therefore, the production of the backing layer 120 is sustainable and places minimum burden to the environment.

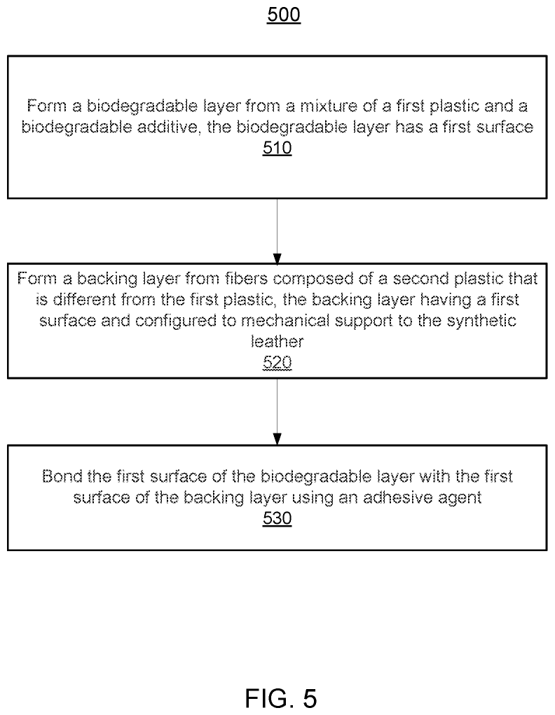

In some embodiments, the backing layer 120 has a dense non-woven structure. The GSM (gram per square meter) of the backing layer 120 is in a range from 300 to 400 g/m². The plastic layers are bonded in a non-woven manner through, e.g., a chemical, mechanical, or thermal treatment. A non-woven backing layer 120 has premium characteristics, such as good absorbency, liquid repellence, stretch, flexibility, and flame retardancy, which provide premium properties to the synthetic leather 100. More details regarding forming the backing layer 120 are described below in conjunction with FIG. 5.

The adhesive layer 130 bonds the backing layer 120 to the biodegradable polyurethane layer 110. In some embodiments, the adhesive layer 130 is formed by applying an adhesive agent on a surface 125 of the backing layer 120 and/or a surface 117 of the biodegradable polyurethane layer 110. The adhesive agent, in one example, is a polyurethane-based synthetic adhesive, natural latex, or a bio-based glue. After the adhesive agent is applied, the biodegradable polyurethane layer 110 and the backing layer 120 are pressed together (e.g., pressure is applied on either side of the layers forcing them inward against the adhesive agent to bond the layers together). The resulting adhesive layer 130 is therefore between the surface 125 of the backing layer 120 and the surface 117 of the biodegradable polyurethane layer 110, which opposes (e.g., is on the opposite side of) the surface 115 of the biodegradable polyurethane layer 110 (surfaces 115 and 117 face outward in opposite directions relative to each other). The adhesive layer has a thickness 139 from 0.001 mm to 0.0013 mm (e.g., 0.001 mm, 0.0011 mm, 0.0013 mm, etc. or any value or sub-range within this range). In some embodiments, there is 3-5 wt % of the adhesive agent in the synthetic leather 100.

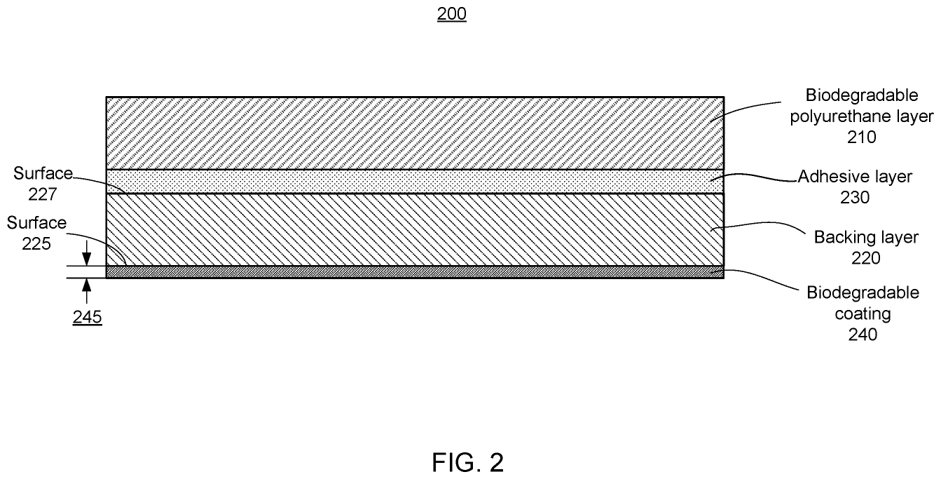

FIG. 2 is a cross-sectional view of another synthetic leather 200, in accordance with an embodiment. The synthetic leather 200 includes a biodegradable polyurethane layer 210, a backing layer 220, and an adhesive layer 230, which are similar to the corresponding components of the synthetic leather 100 as described above in conjunction with FIG. 1. Additionally, the synthetic leather 200 includes a biodegradable coating 240.

The biodegradable coating 240 enhances biodegradability of the synthetic leather 200. The biodegradable coating 240 is a coating of, for example, a biodegradable additive. The biodegradable additive may be the same as or different from the biodegradable additive in the biodegradable polyurethane layer 210. In some embodiments, the biodegradable additive is a powder and is mixed with a solvent to form a mixture. The mixture is sprayed onto (or applied in some other manner) a surface 225 of the backing layer 220, which opposes the surface 227 (e.g., is on the opposite side of the backing layer 220 relative to the surface 227) that is in contact with the adhesive layer 230, to form the biodegradable coating 240. In one example, the ratio of the biodegradable additive to the solvent in the mixture is 1:99. The biodegradable additive may dissolve in the solvent. The solvent may be an organic solvent, e.g., dichloromethane. In some embodiments, the solvent is produced from plants. Surfaces 225 and 227 of the backing layer face outward relative to each other. In some embodiments, the biodegradable coating 240 has a thickness 245 that is 0.5-1% of the total thickness of the synthetic leather 200. The thickness 245 may be in the range from 0.001 to 0.0013 mm (e.g., 0.001, 0.0011, 0.0012, 0.0013 or other values in the range).

In some embodiments, the biodegradable additive in the biodegradable coating 240 is selected based on the plastic in the backing layer 220 and is tailored to enhance biodegradability of the plastic in the backing layer 220. In an example in which the backing layer 220 is made from PET fibers, the biodegradable additive in the biodegradable coating 240 may be a biodegradable PET additive.

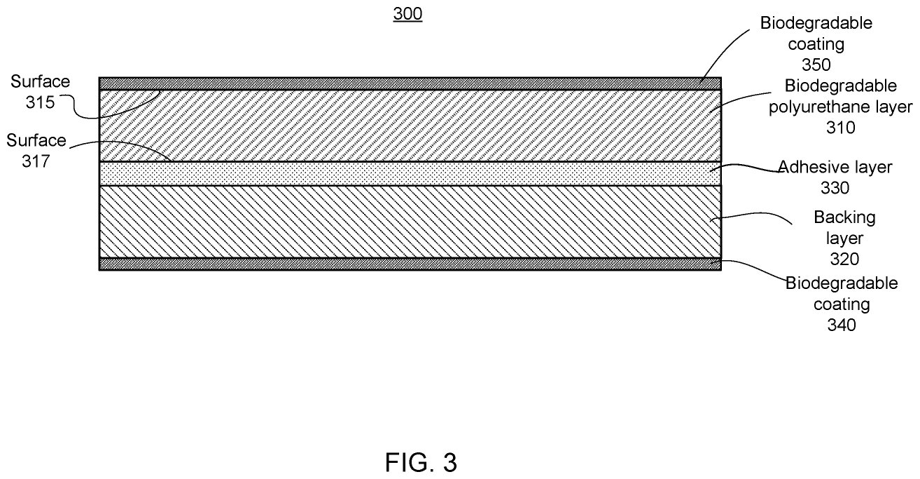

FIG. 3 is a cross-sectional view of yet another synthetic leather 300, in accordance with an embodiment. The synthetic leather 300 includes a biodegradable polyurethane layer 310, a backing layer 320, an adhesive layer 330, and a biodegradable coating 340, which components are similar to the corresponding components of the synthetic leather 200 as described above in conjunction with FIG. 2. Additionally, the synthetic leather 300 includes another biodegradable coating 350.

The biodegradable coating 350 further enhances biodegradability of the synthetic leather 300. Similar to the biodegradable coating 340, the biodegradable coating 350 is a coating of a biodegradable additive, for example. The biodegradable coating 350 may be formed by spraying the biodegradable additive (or otherwise applied) onto a surface 315 of the biodegradable polyurethane layer 310, which opposes the surface 317 of the biodegradable polyurethane layer 310 that is in contact with the adhesive layer 330 (surface 315 sits on the side of the biodegradable polyurethane layer 310 opposite of surface 317). In some embodiments, the biodegradable coating 350 has a thickness 355 that is 0.5-1% of the total thickness of the synthetic leather 300. The thickness 355 is in the range from 3 micrometers to 9 micrometers.

In one embodiment, the biodegradable additive of the biodegradable coating 350 is the same as the biodegradable additive in the biodegradable polyurethane layer 310. In some other embodiments, the biodegradable additive in the biodegradable coating 240 is different from the biodegradable additive in the biodegradable polyurethane layer 210. The thickness 245 may be in the range from 0.001 to 0.0013 mm (e.g., 0.001, 0.0011, 0.0012, 0.0013 or other values in the range).

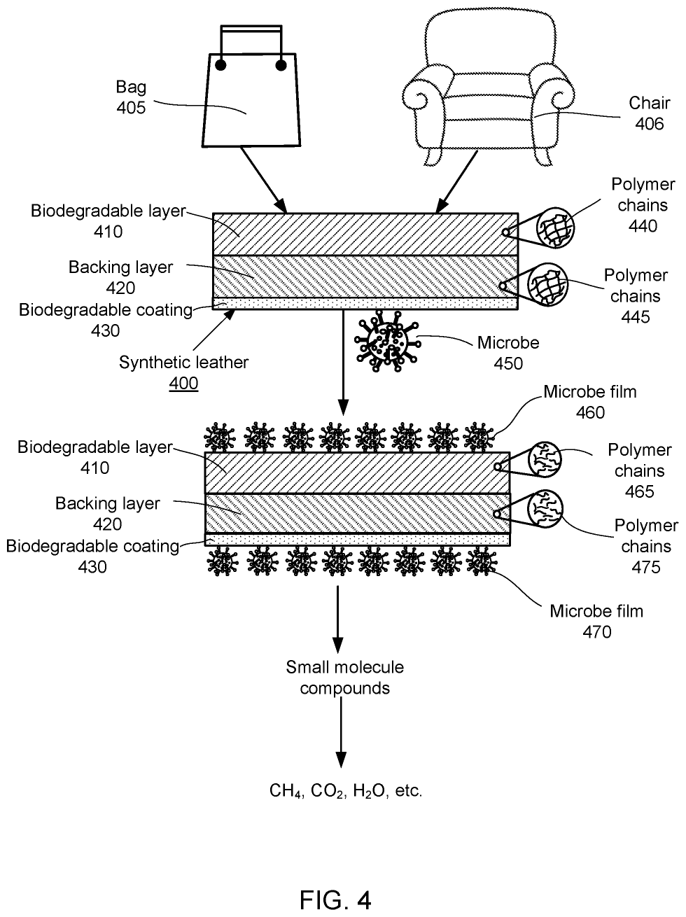

FIG. 4 illustrates a process of natural degradation of a synthetic leather 400, in accordance with an embodiment. The synthetic leather 400 is used to make products, such as the bag 405 and chair 406 in FIG. 4, as an alternative to animal leather. An embodiment of the synthetic leather 400 is the synthetic leather 200 described above.

The synthetic leather 400 includes a biodegradable layer 410, a backing layer 420, and a biodegradable coating 430. The biodegradable layer 410 includes a plastic mixed with a biodegradable additive that enhances degradation of the plastic. In the embodiment of FIG. 4, polyurethane is provided as an example of the plastic in the biodegradable layer 410. The backing layer 420 is made from thermoplastic fibers. In the embodiment of FIG. 4, PET is used as an example of the thermoplastic in the backing layer 420. The polyurethane includes polymer chains 440 that are connected or cross-linked. Similarly, the PET includes polymer chains 445 that are connected or cross-linked. The biodegradable coating 430 is a coating of a biodegradable additive on a surface of the backing layer 420 as shown in FIG. 4, i.e., the surface that does not face the biodegradable layer 410. The biodegradable additive in the biodegradable coating 430 may be the same as or different from the biodegradable additive in the biodegradable layer 410.

When the bag 405 or the chair 406 are released to an ecosystem that includes microbes 450 (individually referred to as microbe 450, and collectively referred to as microbes 450), such as a landfill or natural marine environment, the biodegradable additives attract the microbes 450 so that the microbes 450 accumulate on the surfaces of the synthetic leather 410. As shown in FIG. 4, microbe films 460 and 470 are formed on the two surfaces of the synthetic leather 410. The biodegradable additives increase the surface of the polymer chains 440 and 445 for the microbes 450 to attack and may further assist in enzymatic reactions that enable the microbes to digest and convert polyurethane into elements that can re-enter the ecosystem.

The accumulated microbes 450 break down the polymer chains 440 and 445 of the polyurethane in the synthetic leather 400, e.g., through hydrolysis and/or oxidization. The breaking down of the polymer chains 440 and 445 can be a result of an interaction of polyurethane and PET with enzymes produced by the microbes 450. As shown in FIG. 4, the polymer chains 440 and 445 are disconnected and broken down into shorter polymer chains 465 and 475, respectively. The interaction of the polyurethane and PET with the enzymes can result in small molecule compounds. These small molecule compounds can further be degraded into organic and/or inorganic molecules, such as methane, carbon dioxide, water, etc. In some embodiments, the degraded synthetic leather is in a form that is similar to food waste.

That is, during the natural degradation process, the biodegradation of the synthetic leather 400 is caused by organismic activities that cause disintegration and conversion of the plastics (e.g., polyurethane and PET) into elements that can re-enter the ecological cycle with minimum burden to the environment. The process in FIG. 4 is one example of the degradation process of the synthetic leather 400. However, in other embodiments, the synthetic leather 400 can be naturally degraded through a different process.

FIG. 5 is a flow chart illustrating a method 500 for manufacturing or producing a synthetic leather, in accordance with an embodiment. The synthetic leather is an embodiment of the synthetic leather 100 described above in conjunction with FIG. 1. The method may include different or additional steps than those described in conjunction with FIG. 5 in some embodiments or perform steps in different orders than the order described in conjunction with FIG. 5.

The method 500 includes forming 510 a biodegradable layer from a mixture of a plastic and a biodegradable additive. The biodegradable layer has a first surface. The biodegradable layer is configured to be biodegradable and to provide a feel and look mimicking animal leather. In some embodiments, the biodegradable layer is formed by mixing the plastic (e.g., polyurethane, polyvinyl chloride, other types of plastic, or some combination thereof) in a liquid state with the biodegradable additive in a powder state to form the mixture and heating the mixture at a temperature in a range from 170° C. to 190° C. The mixture is then cooled down, e.g., at a cooling rate of 5° C. in 3-5 seconds. The thickness of the formed biodegradable layer may be 0.20 mm to 0.34 mm. In some embodiments, the biodegradable layer is formed solely from ingredients of plants.

In some embodiments, the biodegradable layer includes a colorant that defines the color of the biodegradable layer. The mixture of the plastic and colorant that results in the colored biodegradable layer is created by mixing the plastic in a liquid state with a colorant in a liquid state. This results in formation of a preliminary mixture. Then the biodegradable additive in a powder state is mixed into the preliminary mixture to form the colored biodegradable layer.

In some embodiments, the biodegradable layer is formed with a pattern that mimics a pattern of animal leather. The pattern can be formed on the biodegradable layer by attaching a template for the pattern on a surface of the biodegradable layer. In one embodiment, the template is a release paper. The template remains on the biodegradable layer during the forming and the biodegradable layer. The template may remain on the biodegradable layer until the biodegradable layer is bonded to a backing layer. The template may be removed after the bonding.

The method 500 also includes forming 520 a backing layer from fibers composed of a second plastic that is different from the first plastic. The backing layer has a first surface and is configured to provide mechanical support to the synthetic leather. The backing layer is formed by bonding the plastic fibers through a non-woven construction. The plastic fibers can be entangled in a non-woven manner through a chemical, mechanical, or thermal treatment. An example of the chemical treatment includes using a bonding agent (e.g., an adhesive resin) to bind the plastic fibers together. An example of the mechanical treatment includes applying physical force on the plastic fibers (e.g., by punching needles through a web of the plastic fibers) to bond the plastic fibers together. An example of the thermal treatment includes heating up the plastic fibers to make them sufficiently hot to adhere to each other.

In some embodiments, the plastic used to form the backing layer is PET, nylon, acrylic, other thermoplastics, or some combination thereof. The plastic fibers are produced from recycled products. Taking recycled bottle as an example, the recycled bottles are sorted and washed. Then the bottles are mechanically broken down into plastic chips. The plastic chips are melted and extruded through a spinning process, in which the melted plastic is spun into fibers with intended size. The plastic fibers can be staple fibers or continuous fibers. The plastic chips may be dried, e.g., through heating, before they are melted and extruded.

The method 500 further includes bonding 530 the first surface of the biodegradable layer with the first surface of the backing layer using an adhesive agent. An example of the adhesive agent is a bio-based adhesive, such as a polyurethane based synthetic adhesive, a bio-based glue, or natural latex. In some embodiments, the biodegradable layer is bonded to the backing layer by applying the adhesive agent on the first surface of the backing layer and apply pressure on the side of the biodegradable layer or by pressing the biodegradable layer and the backing layer against each other with the first surface of the biodegradable layer facing the first surface of the backing layer. The synthetic leather may be heated, e.g., at a temperature in the range from 170° C. to 190° C. during the bonding process and cooled down after the biodegradable layer and backing layer are bonded.

The biodegradable layer has a second surface that opposes its first surface (e.g., the first and second surface are on either side of the biodegradable layer and face outward). The second surface forms the exterior surface of the synthetic leather and provides the look and feel mimicking animal leather. The second surface of the biodegradable layer may have a color and/or pattern, as discussed above. In some embodiments, the method 500 may also include spraying a biodegradable additive onto the second surface of the biodegradable layer to form a biodegradable coating on the second surface of the biodegradable layer. The backing layer also has a second surface that opposes its first surface (the surfaces are on opposite sides of the layer facing outward relative to each other). The second surface is the interior surface of the synthetic leather. In some other embodiments, the method 500 may also include spraying a biodegradable additive onto the second surface of the backing layer to form a biodegradable coating on the second surface of the backing layer.

In one example, the biodegradable additive used to form a biodegradable coating is mixed with a solvent with a ratio of 1:99. The mixture, which may be a liquid, is sprayed onto the second surface of the biodegradable layer to form the biodegradable coating. The biodegradable coating on the second surface of the biodegradable layer or the backing layer can further enhance biodegradability of the synthetic leather so that the synthetic leather can be naturally degraded when it is released into the ecosystem, e.g., a landfill or marine environment. In some embodiments, the biodegradable coating has a thickness that is 0.5% to 1% of a thickness of the synthetic leather.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the disclosure, which is set forth in the following claims.

What is claimed is:

1. A synthetic, leather, comprising:
a biodegradable layer comprising a mixture of a first plastic and a biodegradable additive, the biodegradable layer having a first surface;
a backing layer comprising fibers composed of a second plastic that is different from the first plastic, the backing layer having a first surface and being configured to provide mechanical support to the synthetic leather; and
an adhesive layer between the first surface of the biodegradable layer and the first surface of the backing layer for bonding the biodegradable layer to the backing layer.

2. The synthetic leather of claim 1, wherein the first plastic is polyurethane.

3. The synthetic leather of claim 2, wherein a weight percentage of polyurethane in the synthetic leather is in a range from 40 to 50.

4. The synthetic leather of claim 2, wherein a weight percentage of the biodegradable additive in the synthetic leather is in a range from 1 to 2.

5. The synthetic leather of claim 1, wherein the mixture further comprises a colorant.

6. The synthetic leather of claim 5, wherein a weight percentage of the colorant in the synthetic leather is in a range from 1 to 1.5.

7. The synthetic leather of claim 1, wherein a thickness of the biodegradable layer is in a range from 0.20 mm to 0.34 mm.

8. The synthetic leather of claim 1, wherein the biodegradable layer is solely produced from plants.

9. The synthetic leather of claim 1, wherein the second plastic is polyethylene terephthalate.

10. The synthetic leather of claim 9, wherein the fibers of the second plastic are produced from recycled products that comprise polyethylene terephthalate.

11. The synthetic leather of claim 1, wherein the backing layer is formed by entangling the fibers of the second plastic through a chemical, mechanical, or thermal treatment.

12. The synthetic leather of claim 1, wherein a thickness of the backing layer is in a range from 0.39 to 0.67 mm.

13. The synthetic leather of claim 1, wherein a weight percentage of the adhesive layer in the synthetic leather is in a range from 3 to 5.

14. The synthetic leather of claim 1, wherein a thickness of the adhesive layer in the synthetic leather is in a range from 0.001 mm to 0.0013 mm.

15. The synthetic leather of claim 1, further comprising a coating of a biodegradable additive on a second surface of the backing layer, the second surface of the backing layer on an opposite side of the backing layer relative to the first surface of the backing layer.

16. The synthetic leather of claim 15, wherein the coating of the biodegradable additive is formed by spraying the biodegradable additive onto the second surface of the backing layer.

17. The synthetic leather of claim 15, wherein a thickness of the coating of the biodegradable additive is 0.5% to 1% of a thickness of the synthetic leather.

18. The synthetic leather of claim 1, further comprising a coating of a biodegradable powder on a second surface of the layer of the biodegradable layer, the second surface of the biodegradable layer on an opposite side of the biodegradable layer relative to the first surface of the biodegradable layer.

19. A method of forming a synthetic leather, comprising:
forming a biodegradable layer from a mixture of a first plastic and a biodegradable additive, the biodegradable layer having a first surface;
forming a backing layer from fibers composed of a second plastic that is different from the first plastic, the backing layer having a first surface and being configured to provide mechanical support to the synthetic; leather, and
bonding the first surface of the biodegradable layer with the first surface of the backing layer using an adhesive agent.

20. The method of claim 19, further comprising:
spraying a biodegradable powder onto a second surface of the backing layer to form a biodegradable coating on the second surface of the backing layer, the second surface of the backing layer on an opposite side of the backing layer relative to the first surface of the backing layer.

21. The method of claim 19, further comprising:
spraying a biodegradable powder onto a second surface of the biodegradable layer to form a biodegradable coating on the second surface of the biodegradable layer, the second surface of the biodegradable layer on an opposite side of the biodegradable layer the first surface of the biodegradable layer.

22. The method of claim 19; wherein the first plastic is polyurethane or polyvinyl chloride.

23. The method of claim 22, wherein forming the biodegradable layer comprises:
mixing polyurethane in a liquid state with the biodegradable additive in a powder state to form a mixture;
heating the mixture at a temperature in a range from 170° C. to 190° C.; and
cooling the mixture

24. The method of claim 23; wherein cooling the mixture comprises:
cooling the mixture at a cooling rate of 5° C. in 3-5 seconds.

25. The method of claim 22, wherein forming the biodegradable layer comprises:
mixing polyurethane in a liquid state with a colorant in a liquid state to form a preliminary mixture; and
mixing the biodegradable additive in a powder state to the preliminary mixture.

26. The method of claim 19; wherein forming the biodegradable layer comprises:
forming a pattern that mimics a pattern of animal leather on a second surface of the biodegradable layer, the second surface of the biodegradable layer on an opposite side of the biodegradable layer relative to the first surface of the biodegradable layer, the pattern formed by attaching a template for the pattern on the second surface of the biodegradable layer.

27. The method of claim 26, further comprising:
removing the template from the biodegradable layer after the biodegradable layer is bonded to the backing layer.

28. The method of claim 19, wherein the second plastic is polyethylene terephthalate, nylon, or acrylic.

29. The method of claim 19, wherein forming the backing layer comprises:
entangling the fibers of the second plastic in a non-woven manner.

30. The method of claim 19, wherein a weight percentage of the biodegradable additive in the synthetic leather is in a range from 1 to 2.

31. The method of claim 19, wherein a thickness of the synthetic leather is in a range from 0.6 mm to 1.0 mm.

32. A synthetic leather formed by a method, comprising:
forming a biodegradable layer from a mixture of a first plastic and a biodegradable additive, the biodegradable layer having a first surface;
forming a backing layer from fibers composed of a second plastic that is different from the first plastic, the backing layer having a first surface and being configured to provide mechanical support to the synthetic leather; and
bonding the first surface of the biodegradable layer with the first surface of the backing layer using an adhesive agent.

33. The synthetic leather of claim 32, wherein the first plastic is polyurethane or polyvinyl chloride.

34. The synthetic leather of claim 32, wherein the second plastic is polyethylene terephthalate, nylon, or acrylic.
